(19) United States
(12) Patent Application Publication
(10) Pub. No.: US 2016/0144655 A1
(43) Pub. Date: May 26, 2016

(54) DECORATIVE EGG SYSTEM AND METHOD

(71) Applicant: Wal-Mart Stores, Inc., Bentonville, AR (US)

(72) Inventors: Raychelle Renee Simpson, Bentonville, AR (US); Charles Dewayne Ritter, Bentonville, AR (US)

(21) Appl. No.: 14/947,071

(22) Filed: Nov. 20, 2015

Related U.S. Application Data
(60) Provisional application No. 62/082,916, filed on Nov. 21, 2014.
(60) Provisional application No. 62/203,121, filed on Aug. 10, 2015.

(51) Int. Cl. B44C 1/00; B65D 77/00; B65D 85/32; B65D 65/02; B65B 11/58; B65B 23/02

(52) U.S. Cl. CPC B44C 1/00; B65B 11/58; B65B 23/02; B65D 85/32; B65D 65/02; B65D 77/003

(57) ABSTRACT

A decorative egg is provided. The decorative egg includes a high impact polystyrene (HIPS) material coated with a paint material, the decorative egg having a single smooth continuous surface and configured to hold chalk material, the decorative egg having a solid body.

### CROSS REFERENCE TO RELATED APPLICATION[S]

This application claims priority to U.S. Provisional Patent Application entitled “DECORATIVE EGG SYSTEM AND METHOD,” Ser. No. 62/082,916, filed Nov. 21, 2014, and claims priority to U.S. Provisional Patent Application entitled “DECORATIVE EGG SYSTEM AND METHOD,” Ser. No. 62/203,121, filed Aug. 10, 2015, the disclosures of which are hereby incorporated entirely herein by reference.

### FIELD

The present disclosure relates generally to decorative eggs. More particularly, the present disclosure relates to a decorative egg system and method of making the same.

### BACKGROUND

Conventionally, natural eggs from poultry animals have been used for decorative purposes (e.g., Easter eggs). However, such natural eggs are perishable, breakable, prone to infection, and are not useful for humans with egg allergies. Some conventional eggs are made of hollow plastic and are available in white color. However, such hollow plastic eggs can also be crushed easily and are not steady or stable when a decoration is being applied thereupon. Further, the hollow plastic body of the decorative egg may make it prone to be blown away by moving air, e.g., when used in an outside environment or under/near a fan used for drying the decorations on the plastic egg. Furthermore, when provided to small children, some small children can easily tell that such eggs are not real or natural and do not want to use such eggs due to the poor packaging of such eggs.

### SUMMARY

Accordingly, there is a need for solving these and other drawbacks in decorative eggs. The foregoing needs are met, to a great extent, by the present disclosure, wherein in one aspect, a decorative egg is provided. The decorative egg includes a high impact polystyrene (HIPS) material coated with a paint material, the decorative egg having a single smooth continuous surface and configured to hold chalk material, the decorative egg having a solid body.

In another aspect, a method of making a decorative egg system is provided. The method includes providing a plurality of decorative eggs, each of the plurality of decorative eggs being made of a high impact polystyrene (HIPS) material coated with a paint material, each of the plurality of decorative eggs having a single smooth continuous surface configured to hold chalk material, and each of the plurality of decorative eggs having a solid body, providing a container configured to hold a plurality of decorative eggs, wrapping the container and the plurality of decorative eggs in a transparent wrapping material, and wrapping an opaque cover to at least partially cover the transparent wrapping material around a length of the container, the opaque cover configured to include information about the decorative egg system.

In yet another aspect of this disclosure, a decorative egg system is provided. The decorative egg system includes a plurality of decorative eggs, each of the plurality of decorative eggs being made of a high impact polystyrene (HIPS) material, each of the plurality of decorative eggs having a single smooth continuous surface and having a solid body. The decorative egg system includes a container configured to hold a plurality of decorative eggs, a transparent wrapping material configured to be wrapped around the container and the plurality of decorative eggs, and an opaque cover configured to at least partially cover the transparent wrapping material around a length of the container, the opaque cover configured to include information about the decorative egg system.

There has thus been outlined, rather broadly, an aspect of the disclosure in order that the detailed description thereof herein may be better understood, and in order that the present contribution to the art may be better appreciated. There are, of course, additional aspects of the disclosure that will be described below and which will form the subject matter of the claims appended hereto.

In this respect, before explaining at least one aspect of the disclosure in detail, it is to be understood that the disclosure is not limited in its application to the details of construction and to the arrangements of the components set forth in the following description or illustrated in the drawings. While this disclosure has a decorative egg system, one of ordinary skill the art after reviewing this disclosure will understand that various principles of this disclosure may be applied to a variety of decorative eggs. For example, different types of mixed construction decorative eggs may be used in accordance with the disclosure herein.

The disclosure is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

### BRIEF DESCRIPTION OF THE DRAWINGS

FIG. 1 illustrates a decorative egg, in accordance with an aspect of this disclosure.

FIG. 2 illustrates a cross-section view of the decorative egg of FIG. 1, in accordance with an aspect of this disclosure.

FIG. 3 illustrates a cross-section view of the decorative egg of FIG. 1, in accordance with an alternative aspect of this disclosure.

FIG. 4 illustrates the decorative egg of FIG. 1 having a flat base, in accordance with yet another alternative aspect of this disclosure.

FIG. 5 illustrates the decorative egg of FIG. 1 having a pattern, in accordance with an aspect of this disclosure.

FIG. 6 illustrates a decorative egg system, in accordance with an aspect of this disclosure.

FIGS. 7A, 7B, and 7C illustrate the decorative egg system of FIG. 6 including a plurality of pieces of chalk and/or paint material with rollers, in accordance with an aspect of this disclosure.

FIG. 8 illustrates a container of the decorative egg system of FIG. 6, in accordance with an aspect of this disclosure.

FIG. 9 illustrates an opaque cover of the decorative egg system of FIG. 6, in accordance with an aspect of this disclosure.

FIG. 10 illustrates another view of the decorative egg system of FIG. 6, in accordance with an aspect of this disclosure.

FIG. 11 illustrates the plurality of eggs placed inside the container, in accordance with an aspect of this disclosure.

FIG. 12 illustrates a method for making the decorative egg system, in accordance with an aspect of this disclosure.

### DETAILED DESCRIPTION

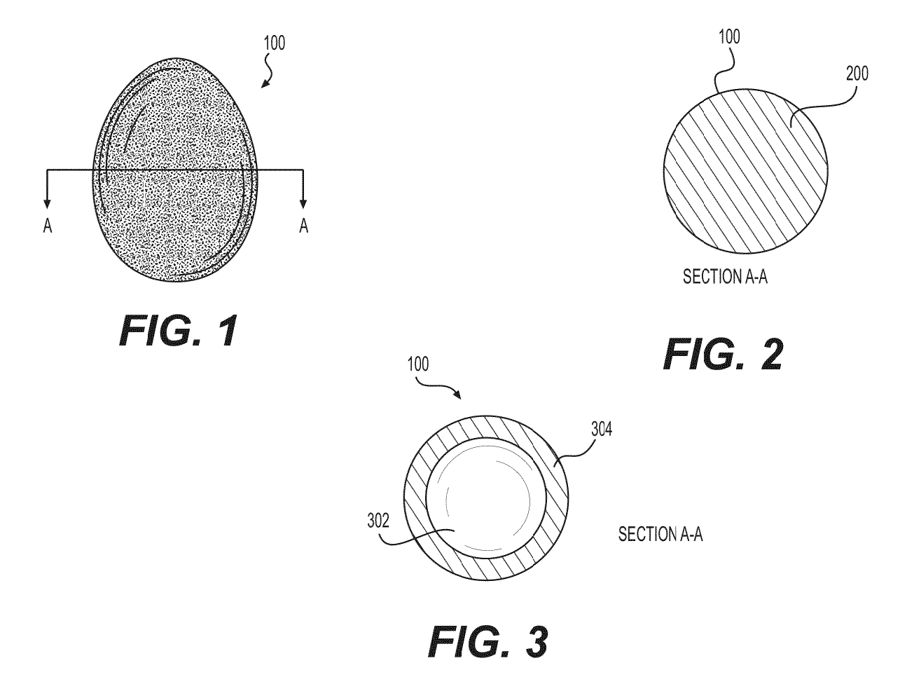

Referring to FIG. 1, a decorative egg 100 is illustrated, in accordance with an aspect of this disclosure. The decorative egg 100 is illustrated in an elevation view in FIG. 1. In one aspect of this disclosure, the decorative egg 100 may include a high impact polystyrene (HIPS) material. The HIPS material may be a hard material (e.g., hard polystyrene).

In one aspect, the decorative egg 100 may be coated with a paint material. The paint material may be pre-coated onto the decorative egg 100 prior to sale of the decorative egg 100. Such a paint material may be a dark colored paint material, by way of example only. The paint material may be pre-coated on the decorative egg 100 such that a user or a buyer of the decorative egg 100 does not need to buy paint material to paint the decorative egg 100. The paint material may be temporary or permanent. Regardless of whether the pain material is temporary or permanent, upon drying, the paint material may make the decorative egg 100 have a chalkboard surface making the decorative egg 100 a chalkboard egg. In an alternative aspect, no paint, a white paint, and/or a light colored paint may be used. In yet another aspect, a combination of dark, light, white, and no paint may be used.

In some aspects, the decorative egg 100 has a single smooth continuous surface. Such a single smooth continuous surface, though smooth, has enough friction to be configured to hold chalk material (not shown in FIG. 1). The single smooth continuous surface is “single”, “smooth” and “continuous” in the sense that there are no holes and partitions on the decorative egg 100. For example, the decorative egg 100 does not have any snap-on mechanisms that may allow the decorative egg 100 to be opened. In this respect, the decorative egg 100 has a solid body. In other words, the decorative egg 100 is not hollow. By way of example, such a solid body of the decorative egg 100 is advantageous in preventing the decorative egg 100 from being blown away by moving air (e.g., from a fan) when the paint material on the decorative egg 100 is being dried. Further, the solid body of the decorative egg 100 is not prone to crushing or collapsing by little kids who may have a tight grip on the decorative egg 100. Additionally, the solid body of the decorative egg 100 makes the decorative egg 100 stable and sturdy when placed on a surface. In one aspect, the decorative egg 100 may have a partially hollow body and a partially solid body. For example, the decorative egg 100 may be solid towards a bottom base to prevent it from toppling under gravity, while the rest of the inside volume of the decorative egg 100 above the solid part is hollow.

In yet another aspect, the decorative egg 100 is a chalkboard egg. For example, the smooth single continuous surface of the decorative egg may have a black, green, or other colored surface to visually contrast the chalk material applied thereupon. The decorative egg 100 is configured to hold the chalk material at least temporarily. Further, the decorative egg 100 is reusable. For example, the decorative egg 100 may be configured to hold the chalk material more than once. Such reusability may be due to the decorative egg 100 being washable or cleanable (e.g., with a wipe).

FIG. 2 illustrates a section A-A of the decorative egg 100 along a center of the decorative egg 100, in accordance with an aspect of this disclosure. As illustrated, the decorative egg 100 in this aspect has a solid inside body.

FIG. 3 illustrates a section A-A of the decorative egg 100 along a center of the decorative egg 100, in accordance with an alternative aspect of this disclosure. As illustrated, the decorative egg 100 in this aspect has a hollow inside body having a volume 302 and a solid portion 304 at a periphery of the decorative egg 100.

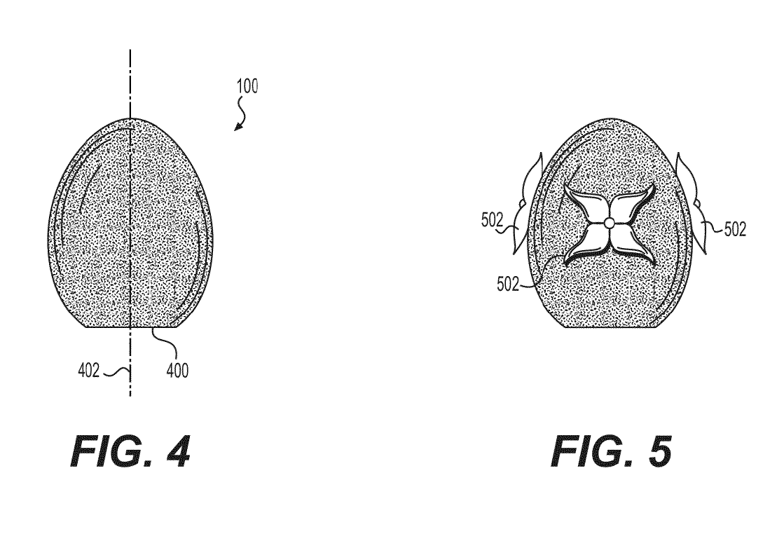

FIG. 4 illustrates the decorative egg 100 having a flat base 400, in accordance with another aspect of this disclosure. The flat base 400 is configured to keep the decorative egg 100 stably upright on a surface. It is to be noted that although the flat base 400 is illustrated towards a bottom part of the decorative egg 100, the flat base 400 may be provided anywhere on the decorative egg 100. For example, the flat base 400 may be provided at an angle to a major axis 402 of the decorative egg 100. Such an angle may vary from 0° to 90° (as shown in FIG. 4).

FIG. 5 illustrates the decorative egg 100 having a pattern 502 on the single smooth surface continuous thereof. The pattern 502 is illustrated to protrude or extend above the single smooth continuous surface. Such protrusion may be from 0 mm to a fraction of a millimeter to a few millimeters, by way of example only and not by way of limitation. The protruding aspect of the pattern 502 may be advantageous, for example, to visually impaired users of the decorative egg 100. In one aspect, the pattern 502, by way of the protruding arrangement, is configured to hold the chalk material. Likewise, in one aspect, the pattern 502 may be sunk below the single smooth continuous surface of the decorative egg 100. In another aspect, the pattern 502 may include both protruding and sunk features to hold the chalk material. As a result, the pattern 502 and/or the surface of the decorative egg 100 may be visually contrasting with each other. By way of example only, the pattern 502 may be any type of decorative pattern of interest to a user of the decorative egg 100, and the specific pattern 502 illustrated in FIG. 5 is by way of example only and not by way of limitation. Further, the aspects of this disclosure covered by the FIGS. 1-5 may be combined with each other in different combinations. For example, the pattern 502 may exist on the decorative egg 100 that also has the flat base 400, the decorative egg 100 being either hollow or solid.

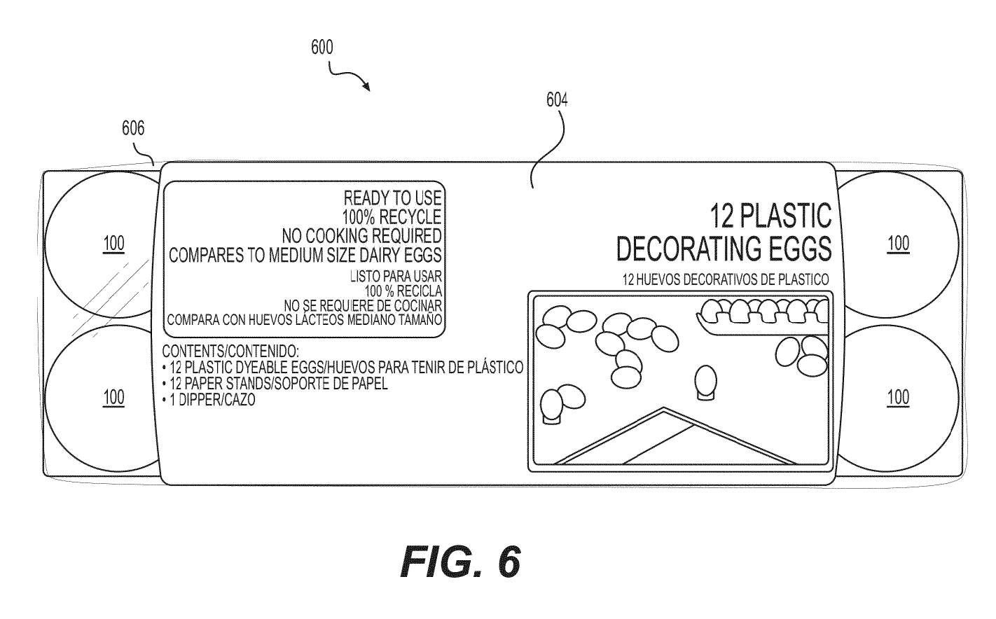

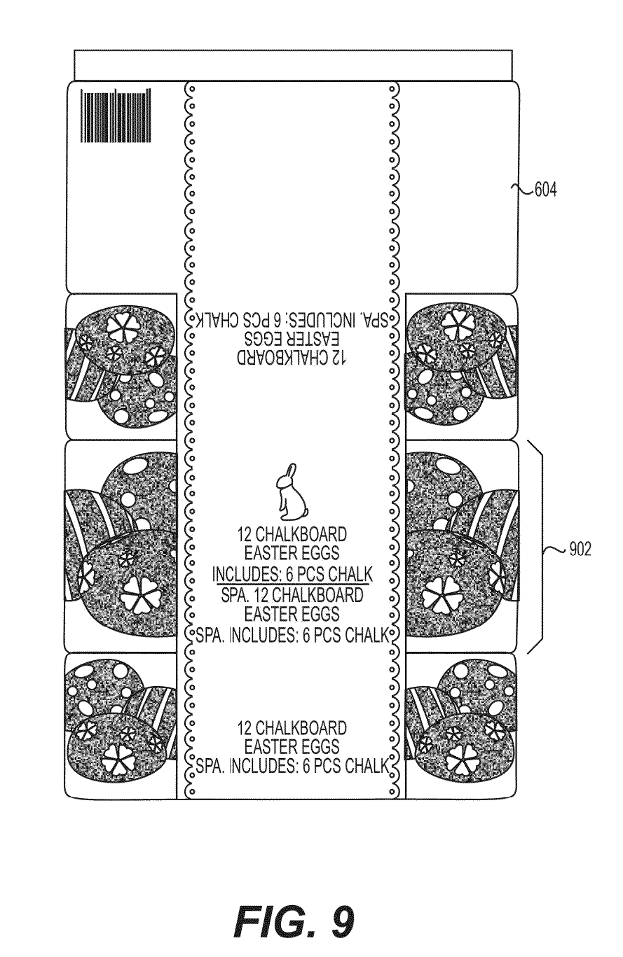

FIG. 6 illustrates a decorative egg system 600, in accordance with an aspect of this disclosure. The decorative egg system 600 may include a plurality of decorative eggs 100 (each similar to and/or including the decorative egg 100). In one aspect, one or more or each of the plurality of decorative eggs 100 is made of a high impact polystyrene (HIPS) material. Further, each of the plurality of decorative eggs 100 has a single smooth continuous surface and has a solid body. Alternatively, the plurality of decorative eggs 100 of the decorative egg system 600 may have a hollow body. In one aspect, one or more of the plurality of decorative eggs 100 may have a solid body, while the remaining ones of the plurality of decorative eggs in the decorative egg system 600 may have a hollow body. The decorative egg system 600 includes a container 602 shaped or configured to hold the plurality of decorative eggs 100. The specific shape of the container 602 makes it harder for young children to differentiate from a natural egg for painting or decorative purpose (e.g., during the Easter season), and parents or guardians of the kids can safely have children enjoy such decorative activities, arts and craft, etc. using the decorative egg system 600. The container 602 may be made of a suitable material such as cardboard, plastic, etc., as illustrated, e.g., in FIGS. 8 and 9.

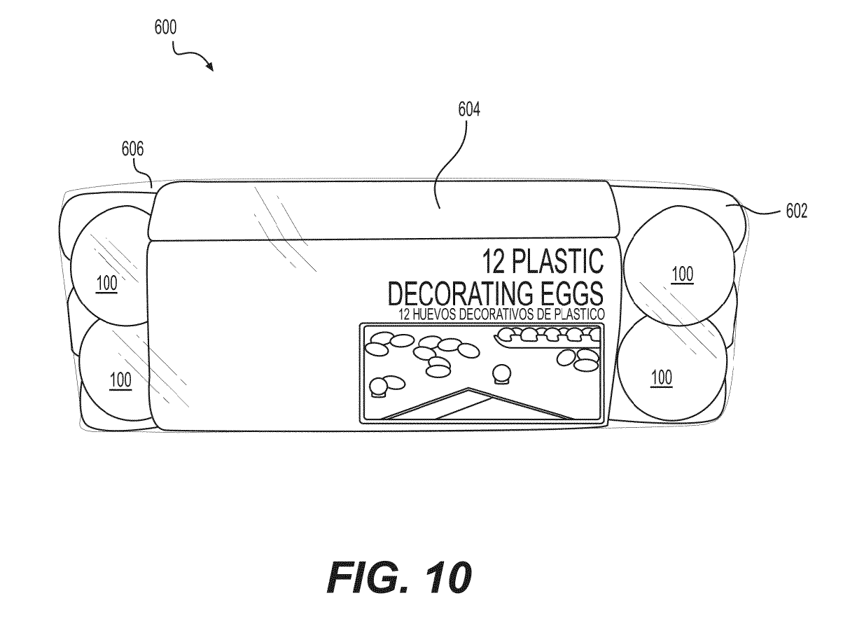

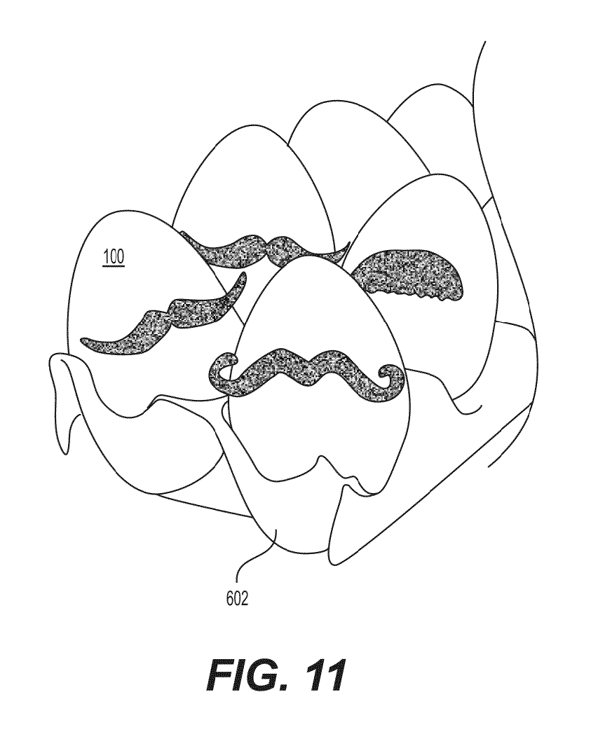

Referring to FIG. 8, the container 602 includes a plurality of compartments 802, for example, to hold the plurality of eggs 100. In one aspect, the container 602 may be similar to an egg carton for natural eggs from poultry, commonly available. FIG. 10 illustrates another view of the decorative egg system 600, in accordance with an aspect of this disclosure. FIG. 11 illustrates an aspect of this disclosure with the container 602 and the plurality of decorative eggs 100 placed therein with moustache-like decorations attached or applied thereupon.

In one aspect, the decorative egg system 600 includes a transparent wrapping material 606 configured to be wrapped around the container 602 and the plurality of decorative eggs 100. The transparent wrapping material 606 may be configured to be wrapped tightly around the plurality of eggs 100 such that the plurality of eggs 100 are positioned securely and do not move relative to each other during transportation. The transparent wrapping material 606 may be cellophane material, by way of example only, though other types of transparent or partially transparent materials could be used. Further, any amount of the transparent wrapping material 606 may be used to tightly hold the plurality of decorative eggs 100. For example, one or more than one layers of the transparent wrapping material 606 may be used. An end of the transparent wrapping material 606 may be fused to the container 602 or to itself to secure the transparent wrapping material 606 in position in the decorative egg system 600.

In one aspect, the decorative egg system 600 includes an opaque cover 604 configured to at least partially cover the transparent wrapping material 606 around a length of the container 602. In one example, the opaque cover 604 is configured to include information about the decorative egg system 600, such information being visible to a potential buyer of the decorative egg system 600. The opaque cover 604 may be made of thin cardboard or paper material, for example, although other types of opaque or partially opaque materials and recyclable materials could be used.

FIG. 9 illustrates an exemplary shape and size of the opaque cover 604, in accordance with an aspect of this disclosure. The opaque cover 604 may include a flap 902 dimensioned as illustrated to wrap around or cover the container 602. Further, the opaque cover 604 may be a single continuous piece whose ends may be attached by various means to wrap at least partially over the transparent wrapping material 606. It is to be noted that the numerical values of the various dimensions of the opaque cover 604 are shown by way of example only and not by way of limitation, as other values for these dimensions may be used.

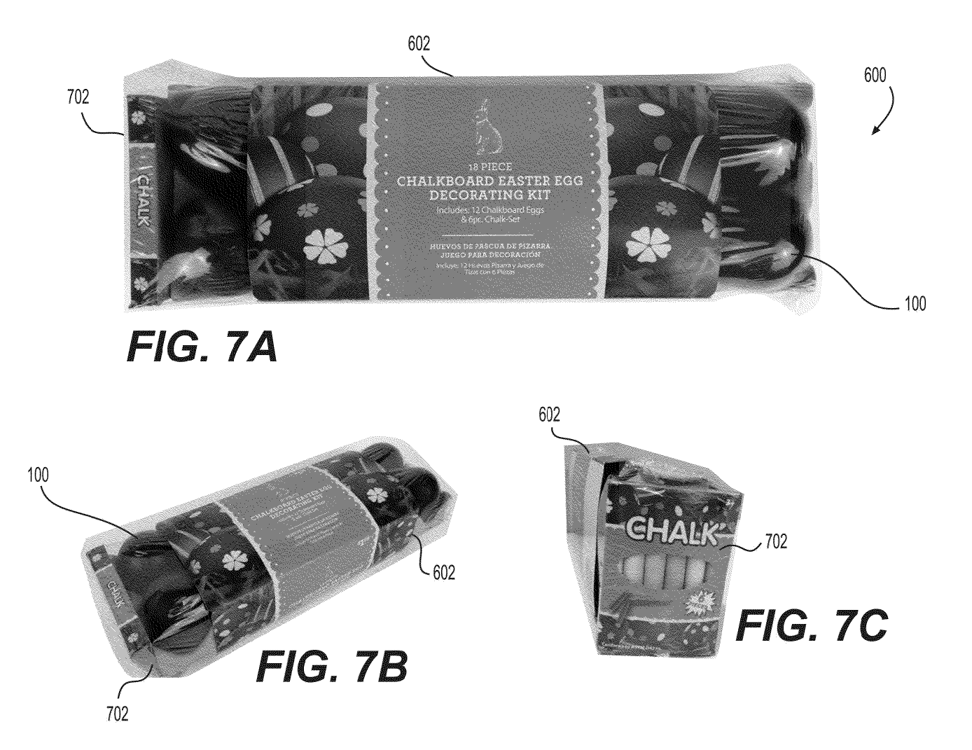

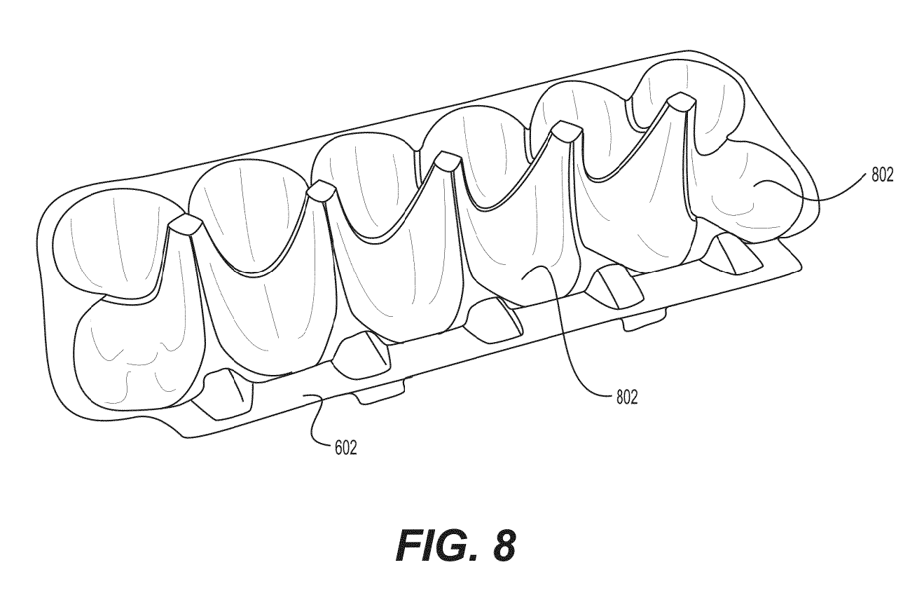

FIGS. 7A, 7B, and 7C illustrate three different views of the decorative egg system 600 with a plurality of pieces of chalk 702 attached to the container 602. In one aspect, the pieces of chalk 702 may instead include a paint material and a roller to apply the paint material on the single smooth continuous surface of the decorative egg 100 included in the plurality of eggs 100. In another aspect, the pieces of chalk 702 as well as the roller may be provided together as a single package of the decorative egg system 600. The pieces of chalk 702 may be of different colors, shapes, and/or sizes. Further, the plurality of chalks 702 may be attached at any part of the container 602, and the attachment of the pieces of chalk 702 to a side of the container 602 as illustrated in FIGS. 7A-7C is by way of example only and not by way of limitation.

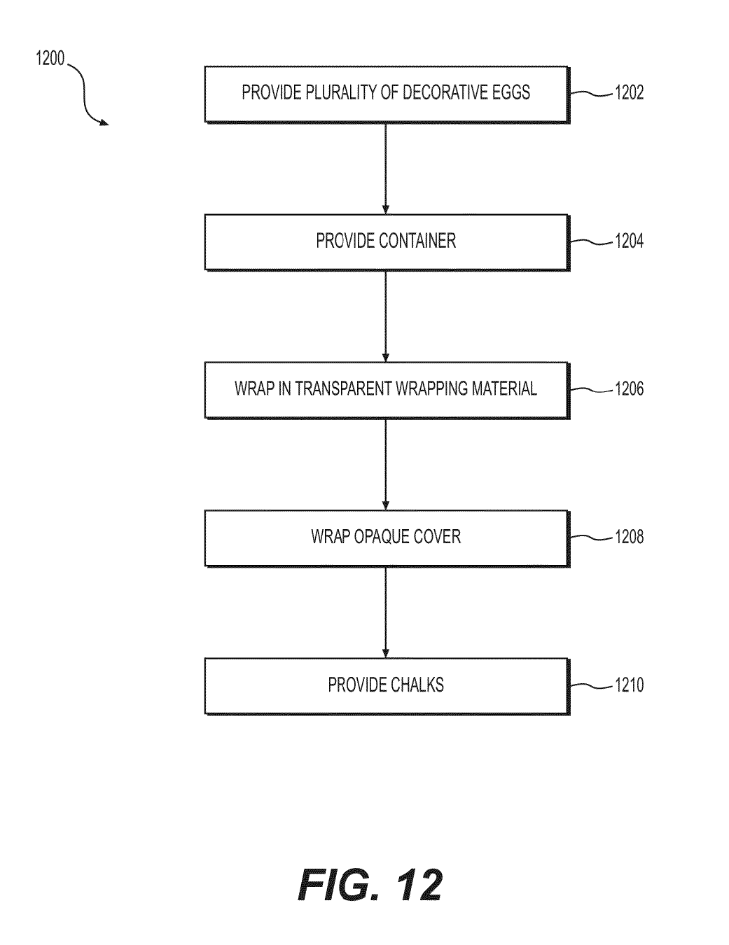

FIG. 12 illustrates a method 1200 for making the decorative egg system 600, in accordance with an aspect of this disclosure. It is to be noted that the steps or operations in the method 1200 may be carried out in any order, and the order shown in FIG. 12 is by way of example only and not by way of limitation. Further, one or more steps may be combined, omitted, or carried out in parallel. The steps of the method 1200 may be carried out by a machine, e.g., in an assembly line for manufacturing the decorative egg system 600 and/or the decorative egg 100.

The method 1200 may begin in an operation 1202 where the plurality of decorative eggs 100 are provided. As discussed, each of the plurality of decorative eggs 100 may be made of a high impact polystyrene (HIPS) material coated with a paint material. Each of the plurality of decorative eggs 100 has a single smooth continuous surface configured to hold chalk material. In one aspect, the plurality of decorative eggs 100 may be provided to have a solid body (e.g., as shown in FIG. 2). Each of the plurality of decorative eggs 100 has a single smooth continuous surface configured to hold chalk material. Alternatively, in one aspect, the plurality of decorative eggs 100 may be provided to have a hollow body (e.g., as shown in FIG. 3). Providing the plurality of decorative eggs 100 may include providing a plurality of chalkboard eggs (e.g., as illustrated in FIGS. 7A-7C) each being pre-coated with a dark colored paint material on the single smooth continuous surface. Further, the providing of the decorative egg system 600 may include providing the plurality of decorative eggs 100 as chalkboard eggs.

In an operation 1204, the container 602 is provided. The plurality of eggs 100 may be held by the container 602. For example, the plurality of eggs 100 may be placed or glued to the container 602.

In an operation 1206, the container 602 may be wrapped in the transparent wrapping material 606. The wrapping may include wrapping the transparent wrapping material 606 around the plurality of eggs 100 placed in the container 602.

In an operation 1208, the opaque cover 604 is provided to at least partially cover the transparent wrapping material 606 around a length of the container 602. In one aspect, the opaque cover 604 is configured to include information about the decorative egg system 600 (e.g., price, precautions, etc.).

In an operation 1210, the pieces of chalk 702 may be provided attached to the container 602 (e.g., as illustrated in FIGS. 7A-7C). Further, instead of or in addition to the pieces of chalk 702, a paint material and a roller to apply the paint material to the plurality of decorative eggs 100 may be provided. During usage, the chalk material or the paint material may be applied to one or more of the plurality of decorative eggs 100. In one aspect, the pieces of chalk 702 may be provided prior to the operation 1206 in which the transparent wrapping material 606 is provided. As a result, the decorative egg system 600 includes the pieces of chalk 702 inside the transparent wrapping material 606 and the opaque cover 604. Alternatively, other positions of the pieces of chalk 702 (shown in FIGS. 7A-7C in a box) may be used, e.g., coupled to an outside surface of the decorative egg system 600.

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

What is claimed is:

1. A decorative egg comprising:
a high impact polystyrene (HIPS) material coated with a paint material, the decorative egg having a single smooth continuous surface.

2. The decorative egg of claim 1, wherein the decorative egg comprises a solid body.

3. The decorative egg of claim 1, wherein the decorative egg comprises a hollow inside body having a volume and a solid portion at a periphery of the decorative egg.

4. The decorative egg of claim 1, wherein the HIPS material is a hard material.

5. The decorative egg of claim 1, wherein the single smooth continuous surface is free of holes and partitions.

6. The decorative egg of claim 1, wherein a dimension of the decorative egg is substantially similar to a natural egg.

7. A container shaped to accommodate a plurality of decorative eggs, said plurality of decorative eggs including the decorative egg of claim 1, said container comprising a wraparound band to contain the plurality of decorative eggs.

8. A method for making a decorative egg system, comprising:
providing a plurality of decorative eggs, each of the plurality of decorative eggs being made of a high impact polystyrene (HIPS) material coated with a paint material, and each of the plurality of decorative eggs having a single smooth continuous surface;
providing a container configured to hold the plurality of decorative eggs;
wrapping the container and the plurality of decorative eggs in a transparent wrapping material; and
wrapping an opaque cover to at least partially cover the transparent wrapping material around a length of the container, the opaque cover configured to include information about the decorative egg system.

9. The method of claim 8, wherein the decorative egg comprises a solid body.

10. The method of claim 8, wherein the decorative egg comprises a hollow inside body having a volume and a solid portion at a periphery of the decorative egg.

11. The method of claim 8, wherein the HIPS material is a hard material.

12. The method of claim 8, wherein the single smooth continuous surface is free of holes and partitions.

13. The method of claim 8, wherein the plurality of decorative eggs have a size substantially similar to a natural egg.

14. A decorative egg system, comprising:
a plurality of decorative eggs, each of the plurality of decorative eggs being made of a high impact polystyrene (HIPS) material, each of the plurality of decorative eggs having a single smooth continuous surface and having a solid body;
a container configured to hold a plurality of decorative eggs in respective compartments of the container;
a transparent wrapping material configured to be wrapped around the container and the plurality of decorative eggs; and
an opaque cover configured to at least partially cover the transparent wrapping material around a length of the container, the opaque cover configured to include information about the decorative egg system.

15. The decorative egg system of claim 14, wherein the decorative egg comprises a solid body.

16. The decorative egg system of claim 14, wherein the decorative egg comprises a hollow inside body having a volume and a solid portion at a periphery of the decorative egg.

17. The decorative egg system of claim 14, wherein the HIPS material is a hard material.

18. The decorative egg system of claim 14, wherein the single smooth continuous surface is free of holes and partitions.

19. The decorative egg system of claim 14, wherein the plurality of decorative eggs have a size substantially similar to a natural egg.

20. A decorative egg comprising:
a high impact polystyrene (HIPS) material coated with a paint material, the decorative egg having a single smooth continuous surface and configured to hold chalk material, the decorative egg having a solid body.

21. The decorative egg of claim 20, wherein the decorative egg is a chalkboard egg with a dark colored paint material on the single smooth continuous surface, and wherein the HIPS material is a hard material.

22. The decorative egg of claim 20, wherein a dimension of the decorative egg is substantially similar to a natural egg.

23. The decorative egg of claim 20, wherein the decorative egg is configured to hold the chalk material at least temporarily.

24. The decorative egg of claim 20, wherein the decorative egg is reusable to hold the chalk material more than once.
